(19) United States
(12) Patent Application Publication
(10) Pub. No.: US 2011/0173655 A1
(43) Pub. Date: Jul. 14, 2011

(54) AUTOMATED SYSTEM AND METHOD FOR GRAPHIC ADVERTISEMENT SELECTION AND OVERLAY

(75) Inventors: Steven G. Blumenschein, Laurel, MD (US); Joseph E. Van Riper, III, Germantown, MD (US)

(73) Assignee: XOrbit, Inc., Columbia, MD (US)

(21) Appl. No.: 12/958,120

(22) Filed: Dec. 1, 2010

Related U.S. Application Data
(60) Provisional application No. 61/265,907, filed on Dec. 2, 2009.

(51) Int. Cl. H04N 7/10

(52) U.S. Cl. 725/35

(57) ABSTRACT

Disclosed is a computer implemented system and method for the automated selection and overlay of graphical advertisements into a video signal. A broadcaster is prompted to confirm an automated selection of suitable graphical advertisements having demographic profiles that match to some extent the demographics of the broadcaster's intended audience. An advertising server receives the broadcaster's confirmation of graphical advertisements that may be overlaid on the broadcaster's intended video program, and forwards those selected graphical advertisements to a video processor, which in turn overlays one or more of the selected graphical advertisements in authorized insertion windows in the broadcaster's video program and forwards the combined video signal/overlaid graphical advertisement through traditional program distribution channels (e.g., cable television, satellite television, and the like).

### CROSS REFERENCE TO RELATED APPLICATION

This application is based upon and claims benefit of copending U.S. Provisional Patent Application Ser. No. 61/265,907 entitled “System and Method for Inserting Sponsor Information into Closed Caption Content of a Video Signal”, filed with the U.S. Patent and Trademark Office on Dec. 2, 2009 by the inventors herein, the specification of which is incorporated herein by reference.

### FIELD OF THE INVENTION

This invention relates generally to the distribution of advertisements in video programming, and more particularly to systems and methods for automatically selecting and overlaying into a video signal graphical advertisements based on electronic demographic profiles of both the graphical advertisement and the programming content within the video transmission.

### BACKGROUND

To fund the development and transmission of broadcast content, broadcasters typically utilize third party advertising, selling time to advertisers in exchange for integrating advertisements into the programming content that is to be broadcast. While the process by which such broadcast advertising is sold and integrated with a broadcast transmission is well developed, television viewers can and often do use recording devices, such as digital video recorders, to skip over advertisements, thus depriving the advertisers the intended benefit that they pay for in purchasing advertising space. It would therefore be advantageous to provide a method and system to present advertisements while the video program proceeds, thus disabling the viewer from skipping over advertising content if they wish to view the full program.

### SUMMARY OF THE INVENTION

Disclosed is a computer implemented system and method that allows for simple, graphical advertisements to be automatically selected and integrated in overlay fashion into a video signal. A collection of potential candidate graphical advertisements is maintained by an advertisement server, each of which has an electronic demographic profile designated by the advertiser. A broadcaster that is registered to use such advertisement server creates their own electronic demographic profile indicating the demographics of their intended audience. The advertising server automatically generates and forwards a list of candidate graphical advertisements to a broadcaster, which list is filtered so that only those graphical advertisements having demographic profiles that match at least to some degree the demographics targeted by the broadcaster are electronically forwarded to the broadcaster, prompting the broadcaster to confirm and/or modify the selection. The advertising server the receives the broadcaster's confirmation of graphical advertisements that may be overlaid on the broadcaster's intended video program, and forwards those selected graphical advertisements to a video processor. The video processor then, in turn, receives the broadcaster's intended video program, overlays one or more of the selected graphical advertisements in authorized insertion windows in the video program, and forwards the combined video signal/overlaid graphical advertisement through traditional program distribution channels (e.g., cable television, satellite television, and the like).

### BRIEF DESCRIPTION OF THE DRAWINGS

The numerous advantages of the present invention may be better understood by those skilled in the art by reference to the accompanying figures in which:

FIG. 1 is a schematic view of a system for the automated selection and overlay of graphical advertisements in accordance with certain aspects of a preferred embodiment of the invention.

FIG. 2 is a flow diagram of a first aspect of a method of operating the system of FIG. 1.

FIG. 3 is a schematic view of a computer hardware system suitable for use in implementing the system of FIG. 1.

### DETAILED DESCRIPTION OF THE PREFERRED EMBODIMENTS

The following description is of a particular embodiment of the invention, set out to enable one to practice an implementation of the invention, and is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Disclosed is an automated system and method for the insertion of multiple graphical advertisement overlays in a video program, which system allows the presentation of advertising content to viewers of the video program while the video program is being presented, thus increasing the opportunity to present advertising during a viewer's viewing experience. With regard to certain aspects of a particularly preferred embodiment of the invention, and by way of summary, a collection of graphical advertisement files is provided and stored on an electronic storage device, such as a database. Each graphical advertisement file comprises a graphical image, such as (by way of non-limiting example) a logo for an advertising company (i.e., an entity that wishes to advertise its product, service, or the like during the presentation of a broadcaster's video program). Each graphical advertisement file is also provided an electronic demographic profile that describes demographic characteristics of the population to which the advertisement is directed. Video program broadcasters that wish to allow such advertisements to be incorporated into their video programs maintain target audiences having particular demographic characteristics that may be maintained in electronic files that relate to each such video program broadcaster. Graphical advertisement files are preferably filtered based upon their electronic demographic profile, and a collection of graphical advertisement files having demographic profiles that match or are complementary to a broadcaster's audience demography electronic file are electronically provided to a broadcaster for review. Upon confirmation of the collection of graphical advertisement files by the broadcaster, the confirmed collection of graphical advertisement files is forwarded to a video processor. The video processor, in turn, preferably generates a playlist that, based upon graphical advertisement display opportunities during the presentation of the particular video program, schedules the overlay of the graphical advertisement during the transmission of the video program. Then, at the time designated by such playlist, a video overlay device overlays the graphical advertisement onto the video program signal, and the combined signal (comprising both the video program and the graphical advertisement) is distributed through appropriate distribution networks to the ultimate viewers. Such method and system thus provide an automated advertisement exchange that allows broadcasters to generate additional revenue by integrating a variety of demographically appropriate, minimally obstructive graphical advertisements in each of their video programs with minimal involvement of the broadcaster.

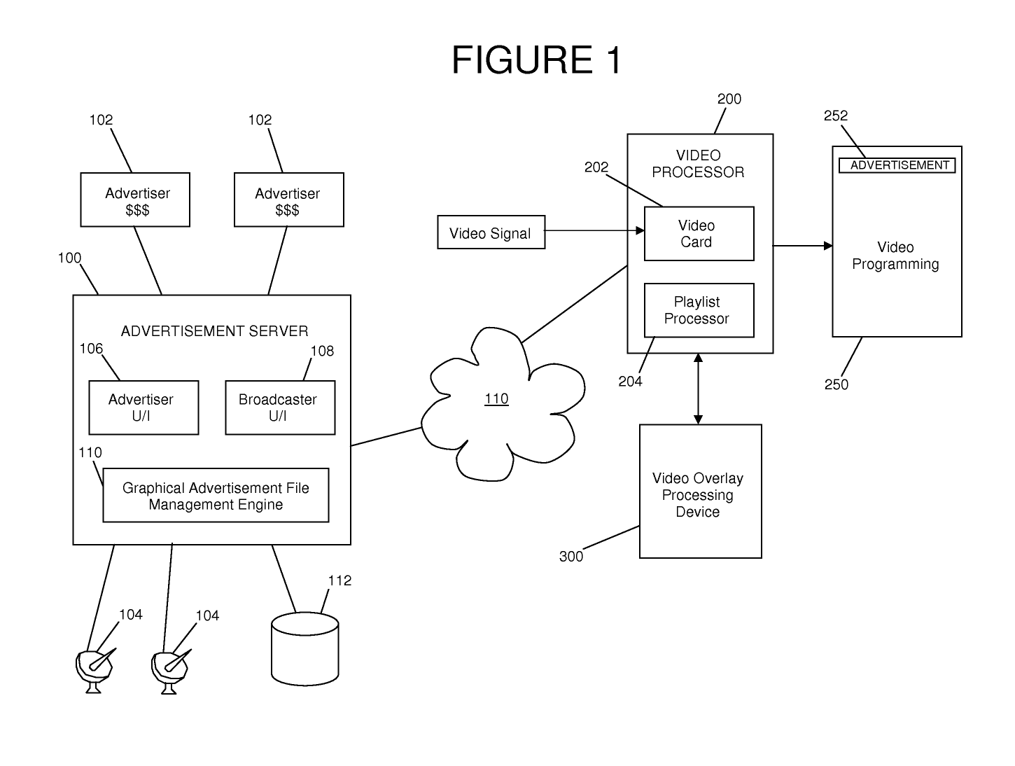

With regard to certain aspects of a particularly preferred embodiment, and with reference to FIG. 1, an exemplary system is shown that provides an automated advertising exchange system allowing broadcasters to choose and/or confirm available graphical advertisements based on audience demographic profiles associated with each advertisement, and for overlaying the selected graphical advertisements onto a video signal for distribution with the content of the video signal. An advertisement server 100 is provided and may be preferably remotely accessed by advertisers 102 and broadcasters 104 to receive graphical advertisement files from advertisers 102 and to interface with broadcasters 104 so as to allow them to select advertisements for overlay in their video designated video signal. Advertisement server 100 preferably communicates with a video processor 200 configured to receive advertisements for inclusion in a broadcaster's video signal, and to overlay those advertisements at the designated times. Advertisement server 100 and video processor 200 preferably communicate with one another across a computer network 110, such as a wide area network such as the Internet. The wide area network 110 preferably provides a delivery mechanism for delivering all types of data, such as audio, video, and/or other data, including metadata, to video processor 200. Those of ordinary skill in the art will nonetheless recognize that other delivery mechanisms may likewise be used for delivery and/or receipt of data amongst the various systems and devices of the current invention, such as a local area network, an Intranet, a private telecommunication line, a “POTS” (plain old telephone system), or other electronic data communication mechanisms without departing from the spirit and scope of the invention. Likewise, while advertisement server 100 and video processor 200 may be separately located computing devices communicated across a network 110, they need not be separate physical computing devices, and may alternatively be configured as separate computer software modules on a single computing system without departing from the spirit and scope of the invention. Still further, multiple advertisement servers 100 (each configured as described below) may be provided and communicated across network 110 to video processor 200, such as by providing one such advertisement server 100 for each broadcaster 104, each baring a unique identification that may be recognized by video processor 200 so as to identify to which broadcaster each such advertisement server 100 is associated when connection between them is established.

In each configuration, advertisement server 100 preferably includes an advertiser interface engine 106 and a broadcaster interface engine 108, as well as a graphical advertisement file management engine 110, and is in communication with one or more data storage devices 112. Data storage device 112, such as a database of traditional configuration, preferably stores graphical advertisement files submitted by advertisers 102. Advertisers 102 may generate a graphical advertisement file for inclusion in data storage device 112 by first engaging advertiser interface engine 106 to import an electronic graphical advertisement that they wish to make available for inclusion in one or more broadcaster's video programming. Such electronic graphical advertisement may comprise, by way of non-limiting example, a graphics file in TARGA (Truevision Advanced Raster Graphics Adapter) file format, although other graphics file formats may be used without departing from the spirit and scope of the invention. In addition to importing such advertisement graphic, an advertiser 102 may designate a demographic profile for such advertisement that reflects that target demographic for such advertisement. The designation of such demographic profile may be accomplished, for example, by selecting (such as by check box selection) particular demographic characteristics from a list of available characteristics, including by way of non-limiting example the intended audience's age, gender, income level, geographic location, and such other demographic characteristics as might be helpful to further delineate intended audience groups. Once the demographic profile for the imported graphic advertisement has been designated, the advertiser 102 may elect to save the resulting graphical advertisement file in data storage 112. In this manner, data storage 112 may serve as a collection of multiple graphical advertisement files from multiple advertisers, each having a unique graphical advertisement and demographic profile, that in turn may be sorted and searched based on preferably each characteristic of their demographic profiles.

Broadcasters 104 may in turn engage broadcaster interface engine 108 to create an electronic broadcaster profile including specific identifying information for such broadcaster, and including preferred demographics for advertisements the broadcaster might wish to include in their video content, which electronic broadcaster profile may likewise be stored on data storage device 112. More particularly, broadcaster interface 108 may present the broadcaster with all available demographic characteristics that advertisers 102 may select for their ads, and prompt the broadcaster to establish one or more profiles by selecting (such as by check box selection) those demographic characteristics that match their intended audience for various video programming. Periodically, a graphical advertisement management engine 110 may automatically generate an email or other electronic message that may be directed to a broadcaster 104, which email contains a pre-screened selection of graphical advertisement files stored in data storage device 112, from which the broadcaster 104 may select which graphical advertisements are to be overlaid onto their video programming content. That pre-screened selection of graphical advertisements is selected at least by filtering the graphical advertisement files in data storage device 112 by their electronic demographic profiles, and providing to the broadcaster 104 only those advertisements that have at least some level of matching demographic characteristics to the broadcaster's own profile. The broadcaster 104 may then review the complete list that was automatically generated by graphical advertisement file management engine 110, and may select those graphical advertisement files that it particularly wishes to include. Graphical advertisement file management agent 110 receives the broadcaster's selection, and in turn serves that selected graphical advertisement to video processor 200 so that it may be overlaid onto the broadcaster's video program as detailed below.

While not shown, advertisement server 100 may also include an accounting module that maintains a record of all advertisements that are selected by broadcasters 104 and in turn incorporated into broadcasters' video programming, such that advertisers 102 may be charged for each display (or on such other basis as a program administrator may select) of their graphical advertisement.

Video processor 200 is configured to receive selected graphical advertisements from advertisement server 100, receive a broadcaster's video signal, and transmit a modified video signal that includes the selected graphical advertisements overlaid onto the broadcaster's designated video signal. To do so, video processor 200 preferably includes a video card 202 that receives the video signal comprising the broadcaster's video programming, and a playlist processor 204 that receives graphical advertisements from advertisement server 100 and generates a playlist that establishes the temporal points in the video program at which each selected graphical advertisement will be overlaid. Video processor 200 is in data communication with a video overlay processing device 300. Such video overlay processing devices are readily commercially available, and may include, by way of non-limiting example, VIZRT, DELTACAST, MIRANDA, and the like, all of which are configured to insert graphics into a video signal. As will be apparent to those skilled in the art, such video overlay processing devices will typically maintain their own preset communications protocol. Video processor 200 is thus configured to communicate with such video overlay processing device according to its communication protocol as is necessary to allow video overlay processing device 300 to process the particularly intended graphic advertisement, the position at which the graphic is to be displayed on the video screen, the duration for which the graphic is to be displayed, and any other data that may be required or desirable as dictated by the third party graphics system to effectively present the desired graphic advertisement to the viewer. Once such processing has been carried out by video overlay processing device 300, video processor 200 outputs a finished video signal 250 containing both the broadcaster's original video programming and an overlay 252 of the graphic advertisement at the times that have been designated by video processor 200. The finished video signal 250 may then be distributed through traditional video programming distribution channels, such as cable television, satellite television, and the like.

As an alternative to causing video processor 200 to generate a playlist that dictates the insertion time or times for a graphical advertisement overlay, such insertion may be triggered by the occurrence of a particular event during a video broadcast. By way of non-limiting example, video processor 200 may monitor the incoming video signal for a change from a pre-recorded video broadcast to a live broadcast, which change will typically provide a short interruption suitable for display of a brief advertisement, and in turn cause video overlay processing device 300 to process a graphical advertisement for immediate overlay onto the video signal upon the occurrence of such event. Those of ordinary skill in the art will recognize that the incoming video signal may be monitored for the occurrence of various other events that would be suitable as triggering events for overlaying an advertisement.

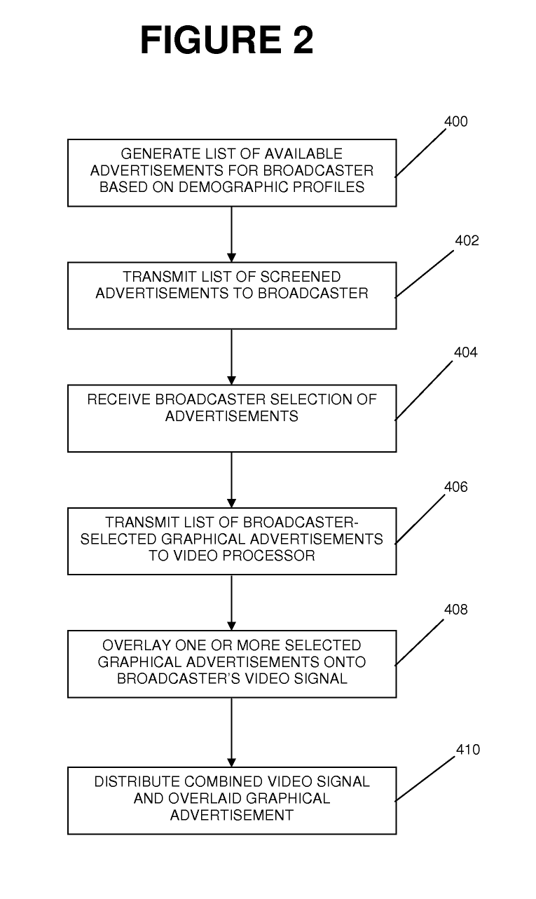

FIG. 2 provides a flow diagram of a method implemented by the above-described system. First, at step 400, advertisement server 100 generates a list of available advertisements for a broadcaster that is registered with the advertisement server. Those advertisements are compiled from data storage device 112 based on the demographic profile of each advertisement, and the demographic profile that the particular broadcaster for whom the list is intended has designated. At step 402, advertisement server 100 transmits the list to a broadcaster 104. At step 106, advertisement server 100 receives back from the broadcaster 104 the selection of advertisements that the broadcaster deems appropriate for inclusion with selected programming content of that broadcaster. Advertisement server 100 then at step 406 forwards the list of selected graphical advertisements to video processor 200. Thereafter, at step 408, video processor 200 overlays one or more of the selected graphical advertisements onto the broadcaster's video signal. As explained above, the graphical advertisement may be inserted according to an insertion schedule determined by playlist processor 204, or may be triggered by the occurrence of a particular event in the broadcast transmission. At step 410, the combined video signal and overlaid graphical advertisement is distributed through traditional video program distribution channels.

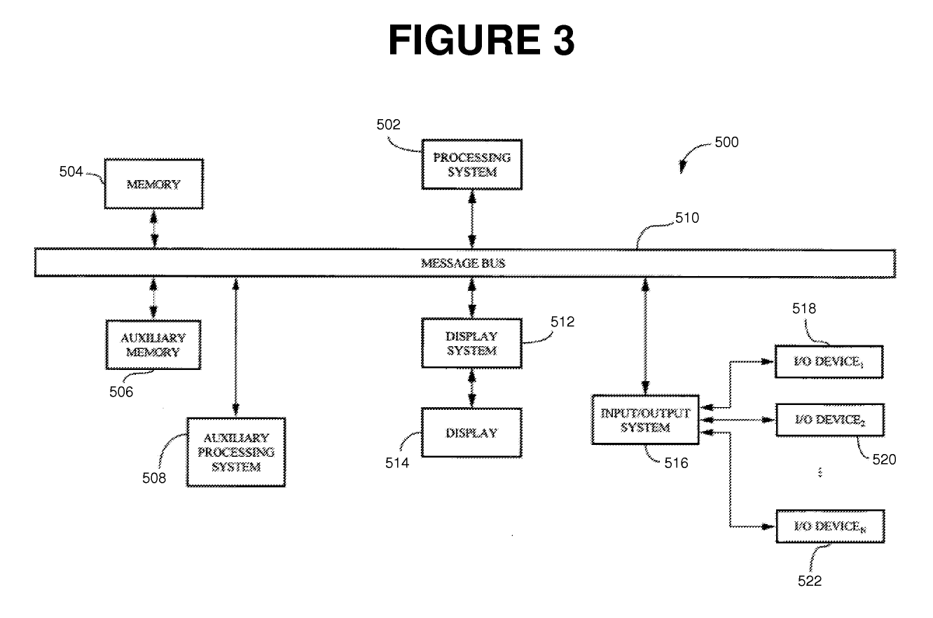

Advertisement server 100 and video processor 200 may be hosted on one or more server computers configured to communicate with client and other interconnected computing devices using TCP/IP packets. An exemplary hardware system generally representative of a computing device suitable for such uses is shown in FIG. 3. In each case, a central processing system 502 controls the hardware system 500 for each of the advertisement server 100 and the video processor 200. A central processing unit such as a microprocessor or microcontroller for executing programs is included in the central processing system 502 for the performance of data manipulations and controlling the tasks of the hardware system 500. A system bus 510 provides the communication with the central processor 502 for transferring information among the components of the hardware system 500. Facilitating information transfer between storage and other peripheral components of the hardware system may be a data channel that may be included in bus 510. Further, the set of signals required for communication with the central processing system 502 including a data bus, address bus, and control bus is provided by bus 510. It is contemplated that any state of the art bus architecture according to promulgated standards may be utilized for bus 510, for example industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and so on.

A main memory 504 and auxiliary memory 506 (including an auxiliary processing system 508, as required) may be provided. The storage of instructions and data for programs executing on the central processing system 502 is provided by main memory 504. Typically semiconductor-based memory such as dynamic random access memory (DRAM) and/or static random access memory (SRAM) is used for the main memory 504. However, main memory 504 may utilize other semi-conductor-based memory types, such as synchronous dynamic random access memory (SDRAM), Rambus dynamic random access memory (RDRAM), ferroelectric random access memory (FRAM), and so on. The storage of instructions and data that are loaded into the main memory 504 before execution is provided by auxiliary memory 506. The storage capabilities provided by the auxiliary memory 506 may include semiconductor based memory such as read-only memory (ROM), programmable read-only memory (PROM), erasable programmable read-only memory (EPROM), electrically erasable read-only memory (EEPROM), or flash memory (block oriented memory similar to EEPROM). Alternatively, a variety of non-semiconductor-based memories, including but not limited to floppy disk, hard disk, magnetic tape, drum, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and other varieties of memory devices as contemplated may be used for auxiliary memory 506.

Auxiliary processors of the auxiliary processing system 508, which are discrete or built into the main processor, may be included in hardware system 500. These auxiliary processors may be used as a digital signal processor (a special-purpose microprocessor having an architecture suitable for fast execution of signal processing algorithms), as a back-end processor (a slave processor subordinate to the main processing system), as an additional microprocessor or controller for dual or multiple processor systems, or as a coprocessor. They may also be used to manage input/output and/or to perform floating point mathematical operations.

A display system 512 for connecting to a display device 514, wherein the display system 512 may comprise a video display adapter having all of the components for driving the display device, including video memory, buffer, and graphics engine as desired, is included in hardware system 500. Video memory may be, for example, windows random access memory (WRAM), video random access memory (VRAM), synchronous graphics random access memory (SGRAM), and the like. The display device 514 may comprise a cathode ray-tube (CRT) type display such as a monitor or television, or an alternative type of display technology such as a projection-type CRT display, a light-emitting diode (LED) display, a gas or plasma display, an electroluminescent display, a vacuum fluorescent display, a cathodoluminescent (field emission) display, a liquid-crystal display (LCD) overhead projector display, an LCD display, a plasma-addressed liquid crystal (PALC) display, a high gain emissive display (HGED), and so forth.

An input/output (I/O) system 516 for connecting to one or more I/O devices 518, 520, and up to N number of I/O devices 522 is included in hardware system 500. Interface functions between the one or more I/O devices 518-522 may be provided by various controllers or adapters. I/O devices such as a keyboard, mouse, trackball, touchpad, joystick, trackstick, infrared transducers, printer, modem, RF modem, bar code reader, charge-coupled device (CCD) reader, scanner, compact disc read-only memory (CD-ROM), digital versatile disc (DVD), video capture device, touch screen, stylus, electroacoustic transducer, microphone, speaker, and others may be communicatively coupled by various interface mechanisms, such as universal serial bus (USB) port, universal asynchronous receiver-transmitter (UART) port, serial port, IEEE 1394 serial bus port, infrared port, network adapter, parallel port, printer adapter, radio-frequency (RF) communications adapter, and others. Analog or digital communication capabilities between the hardware system 500 and the input/output system 516 and I/O devices 518-522 may be provided for communication with external devices, networks, or information sources. Preferably industry promulgated architecture standards are implemented by system 516 and I/O devices 518-522, including Ethernet IEEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on. It is to be understood that modification or reconfiguration of the hardware system 500 of FIG. 3 by one having ordinary skill in the art would not depart from the scope or the spirit of the present invention.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

I claim:

1. A computer implemented method for the automated selection and overlay of graphical advertisements into a video transmission, comprising the steps of:
causing an advertisement server computer to provide to a broadcaster a customized list of candidate electronic graphical advertisements, said customized list being automatically selected based on a match of at least a portion of an advertisement electronic demographic profile with a broadcaster's electronic target audience demographic profile;
receiving at said advertisement server computer a selection from said customized list of approved electronic graphical advertisements from said broadcaster;
overlaying at least one graphical advertisement selected from said approved electronic graphical advertisements on a video signal from said broadcaster; and
distributing the resulting combined video signal and overlaid graphical advertisement through one or more video distribution channels.

2. The computer implemented method of claim 1, wherein said advertisement server computer is in data communication with a data storage device having multiple electronic graphical advertisements stored thereon, each said electronic graphical advertisement having an electronic demographic profile associated therewith, the method further comprising the step of:
receiving at said advertisement server computer a broadcaster's electronic target audience demographic profile, and generating said customized list by selecting electronic graphical advertisements having at least some matching demographic characteristics with said broadcaster's electronic target audience demographic profile.

3. The computer implemented method of claim 1, further comprising the steps of:
forwarding said selection of approved electronic graphical advertisements to a video processor computer; and
causing said video processor computer to generate a playlist designating a temporal insertion point in a video signal for said at least one graphical advertisement selected from said approved electronic graphical advertisements;
wherein said at least one graphical advertisement selected from said approved electronic graphical advertisements is overlaid onto said video signal at said temporal insertion point.

4. The computer implemented method of claim 1, further comprising the step of:
receiving at said advertisement server computer multiple electronic graphical advertisement files from multiple, distinct advertisers, wherein each electronic graphical advertisement file further comprises an electronic graphical advertisement and an electronic demographic profile describing an intended audience for said electronic graphical advertisement.

5. The computer implemented method of claim 4, further comprising the step of:
receiving at said advertisement server computer from at least one broadcaster an electronic target audience demographic profile describing an intended audience for programming content contained in said video signal from said broadcaster.

6. The computer implemented method of claim 5, wherein automatic selection of said customized list further comprises causing said advertisement server computer to compare said electronic target audience demographic profile to said electronic demographic profiles of each of said electronic graphical advertisement files, and selecting for inclusion on said customized list those electronic graphical advertisement files that have some matching demographic characteristics to said electronic target audience demographic profile.

7. A system for automated selection and overlay of graphical advertisements into a video transmission, comprising:
an advertisement server computer having executable computer code stored thereon adapted to:
provide to a broadcaster a customized list of candidate electronic graphical advertisements, said customized list being automatically selected by said advertisement server computer based on a match of at least a portion of an advertisement electronic demographic profile with a broadcaster's electronic target audience demographic profile; and
receive a selection from said customized list of approved electronic graphic advertisements from said broadcaster; and
a video processor computer in data communication with said advertisement server computer and having executable computer code stored thereon adapted to:
overlay at least one graphical advertisement selected from said approved electronic graphical advertisements on a video signal from said broadcaster; and
distribute a resulting combined video signal and overlaid graphical advertisement through one or more video distribution channels.

8. The system of claim 7, further comprising a data storage device in data communication with said advertisement server computer, said data storage device having multiple electronic graphical advertisements stored thereon, each said electronic graphical advertisement having an electronic demographic profile associated therewith, said advertisement server computer having further executable computer code adapted to:
receive a broadcaster's electronic target audience demographic profile, and generate said customized list by selecting electronic graphical advertisements having at least some matching demographic characteristics with said broadcaster's electronic target audience demographic profile.

9. The system of claim 7, said video processor computer having further executable computer code adapted to:
generate a playlist designating a temporal insertion point in a video signal for said at least one graphical advertisement selected from said approved electronic graphical advertisements;
wherein said at least one graphical advertisement selected from said approved electronic graphical advertisements is overlaid onto said video signal at said temporal insertion point.

10. The system of claim 7, said advertisement server computer having further executable computer code adapted to:
receive multiple electronic graphical advertisement files from multiple, distinct advertisers, wherein each electronic graphical advertisement file further comprises an electronic graphical advertisement and an electronic demographic profile describing an intended audience for said electronic graphical advertisement.

11. The system of claim 10, said advertisement server computer having further executable computer code adapted to:
receive from at least one broadcaster an electronic target audience demographic profile describing an intended audience for programming content contained in said video signal from said broadcaster.

12. The system of claim 11, wherein automatic selection of said customized list further comprises comparing said electronic target audience demographic profile to said electronic demographic profiles of each of said electronic graphical advertisement files, and selecting for inclusion on said customized list those electronic graphical advertisement files that have some matching demographic characteristics to said electronic target audience demographic profile.
